(19) United States
(12) Patent Application Publication
(10) Pub. No.: US 2005/0135725 A1
(43) Pub. Date: Jun. 23, 2005

(54) Laser submounts with standoff structures

(75) Inventors: Eric W. Hemmesch, Woodbury, MN (US); Michael A. Haase, St. Paul, MN (US); Thomas J. Miller, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/744,694

(22) Filed: Dec. 23, 2003

(51) Int. Cl. G02B 6/42

(52) U.S. Cl. 385/14

(57) ABSTRACT

A submount for use in an optical assembly and an optical assembly comprising the submount, a laser diode and a second optical element are provided, where the submount comprises a substrate and a plurality of standoff structures. The standoff structures may be formed by patterned deposition onto the substrate. The substrate and standoff structures may be composed of different materials. Typically, the substrate comprises a material selected from the group consisting of: diamond, diamond-like materials, boron nitride and aluminum nitride. The submount may comprise solder layers adjacent to the standoff structures, which may be greater in height from the substrate than the standoff structures.

### FIELD OF THE INVENTION

This invention relates to an optical assembly which includes a laser diode in optical alignment with a second optical element, both elements being mounted on a submount having deposited standoff structures.

### BACKGROUND OF THE INVENTION

Laser diodes may be used for, e.g., optical communications, printing, generation of light by second harmonic generation, and medical applications. They are frequently used in conjunction with optical fibers.

U.S. Patent App. Pub. 2003/0007535 discloses a laser having a laser diode coupled with a passive intra-cavity tapered waveguide, the disclosure of which is incorporated herein by reference.

U.S. Patent App. Pub. 2003/0133668 purportedly discloses packaging and alignment methods for optical components, including photodiode array chips, laser diode chips or optical fiber arrays. The method includes use of a submount with a standoff structure protruding from its surface.

U.S. Patent App. Pub. 2003/0110328 purportedly discloses an optical assembly including a submount with a standoff structure.

### SUMMARY OF THE INVENTION

Briefly, the present invention provides an optical assembly comprising: a) at least one laser diode, b) at least one second optical element, and c) a submount comprising a substrate and a plurality of standoff structures formed by patterned deposition onto the substrate, wherein the laser diode and second optical element contact the standoff structures. Typically, the substrate comprises a material selected from the group consisting of: diamond, diamond-like materials, boron nitride and aluminum nitride. Typically the second optical element is a planar optical waveguide. Typically the substrate and standoff structures are composed of different materials.

In another aspect, the present invention provides an optical assembly comprising: a) at least one laser diode, b) at least one second optical element, and c) a submount comprising a substrate and a plurality of standoff structures, wherein the substrate and standoff structures are composed of different materials, and wherein the laser diode and second optical element contact the standoff structures. Typically, the substrate comprises a material selected from the group consisting of: diamond, diamond-like materials, boron nitride and aluminum nitride. Typically the second optical element is a planar optical waveguide.

In another aspect, the present invention provides a submount for use in an optical assembly comprising at least one laser diode and at least one second optical element, where the submount comprises a substrate, a plurality of standoff structures, and solder layers adjacent to the standoff structures, wherein the standoff structures are formed by patterned deposition onto the substrate. Typically, the substrate comprises a material selected from the group consisting of: diamond, diamond-like materials, boron nitride and aluminum nitride. Typically the substrate and standoff structures are composed of different materials.

In another aspect, the present invention provides a submount for use in an optical assembly comprising at least one laser diode and at least one second optical element, where the submount comprises a substrate, a plurality of standoff structures, and solder layers adjacent to the standoff structures, wherein the substrate and the standoff structures are composed of different materials. Typically, the substrate comprises a material selected from the group consisting of: diamond, diamond-like materials, boron nitride and aluminum nitride.

In another aspect, the present invention provides a submount for use in an optical assembly comprising at least one laser diode and at least one second optical element, where the submount comprises a substrate, a plurality of standoff structures, and solder layers adjacent to the standoff structures, wherein the solder layers are greater in height from the substrate than the standoff structures. Typically, the substrate comprises a material selected from the group consisting of: diamond, diamond-like materials, boron nitride and aluminum nitride. Typically the substrate and standoff structures are composed of different materials. Typically the standoff structures are formed by patterned deposition onto the substrate.

The symbol “Å” represents angstroms, regardless of any typographical or computer error.

The symbol “μm” represents micrometers (microns), regardless of any typographical or computer error.

It is an advantage of the present invention to provide a submount for an optical assembly which provides vertical alignment of a laser element with a second optical element and which can be made using materials that are difficult to etch, such as diamond and the like.

### BRIEF DESCRIPTION OF THE DRAWING

FIG. 1 is a schematic edge-on view of a submount for use in an optical assembly according to the present invention.

FIG. 2 is a schematic depiction of a submount, laser diode and second optical element for use in constructing an optical assembly according to the present invention.

FIG. 3 is a schematic depiction of an optical assembly according to the present invention.

### DETAILED DESCRIPTION

Laser diodes have found uses in optical communications, printing, medical applications, and numerous other fields of technology. A typical laser diode apparatus includes a laser diode chip that is optically coupled with a second optical element, such as a planar optical waveguide, which receives the light generated in the laser diode chip. Proper alignment of these two elements is crucial to the operation of the device. In addition, these two elements must be mounted so that adequate heatsinking and electrical connections can be provided, and so that they are firmly bound. The submount according to the present invention comprises standoff structures which assist in alignment of the laser chip and the second optical element along the Z axis, i.e., the axis normal to the submount. The standoff structures do not interfere with the function of the submount and solder as heat sink, electrical contact, and binding for the laser and second optical element.

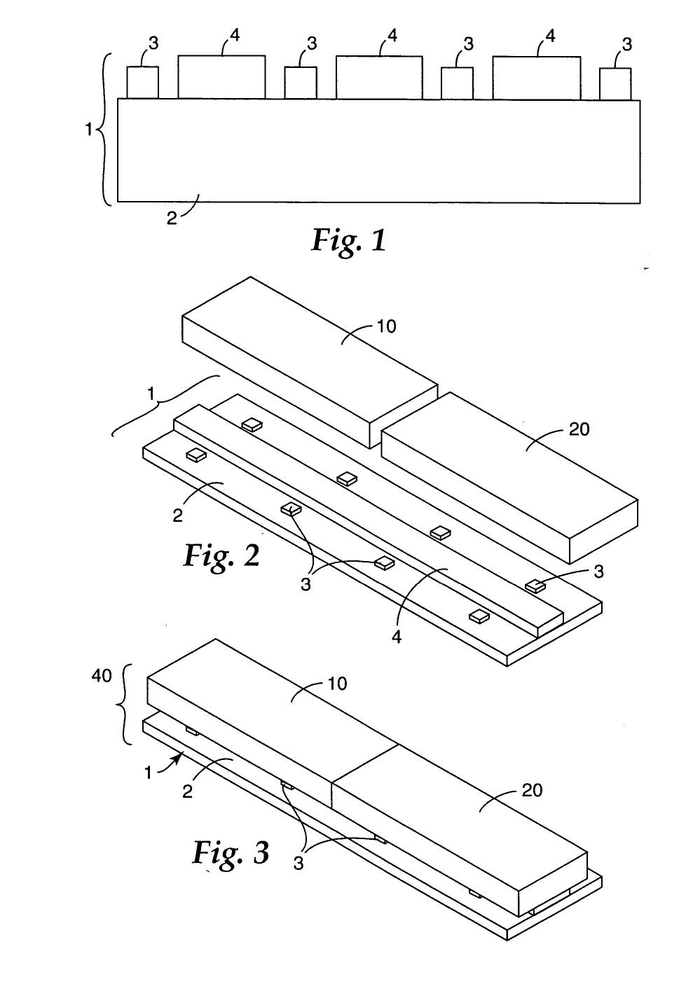

With reference to FIGS. 1-3, the submount 1 according to the present invention comprises a substrate 2, and standoff structures 3. The substrate 2 and standoff structures 3 can be made of the same materials or, more typically, are made of different materials. The substrate 2 may be made of any suitable material, which may include metals, including Ti, Cu or alloys thereof, silicon or alloys or compounds thereof, germanium or alloys or compounds thereof, diamond or diamond-like materials, AlN, BN, other nitrides, other ceramics, and the like. The standoff structures 3 may be made of any suitable material, which may include metals, including Ti, Cu or alloys thereof, silicon or alloys or compounds thereof, germanium or alloys or compounds thereof, and the like. In one embodiment, the substrate 2 is made of a material which is not easily formed by cutting or etching, such as diamond or diamond-like materials, AlN, BN, other nitrides, other ceramics, and the like. Diamond-like materials may be such as those disclosed in Intl. Pat. App. No. WO 01/66820, incorporated herein by reference. In this embodiment, the standoff structures 3 are typically made by patterned deposition. Furthermore, in this embodiment, the standoff structures 3 may be made of a different material than the substrate 2.

The dimensions of the submount 1 are adapted to the size of the laser diode chip 10 and second optical element 20 to be mounted thereon. Where the submount 1 is narrower than the laser diode 10, excess solder cannot contact the scribed edge of the laser diode and potentially short circuit the pn junction. Alternately, the solder 4 may be patterned so as to avoid the edges of the laser diode, as depicted in FIG. 2, and thus avoid potential short circuits.

Standoff structures 3 may take the form of ridges, as depicted in FIG. 1, posts, as depicted in FIGS. 2 and 3, or any pattern suitable for support and alignment of the laser diode chip and second optical element to be mounted thereon. The dimensions of standoff structures 3 are adapted to the size of the laser diode chip 10 and second optical element 20 to be mounted thereon. Typically, the width of the standoff features is between 5 and 100 microns, more typically between 10 and 75 microns. Typically, the height of the standoff features is between 0.5 and 5 microns, more typically between 1 and 3 microns. Where posts are used, a minimum of three and more typically four posts support each optical element.

Standoff structures 3 may be formed by any suitable method, but are typically deposited. Standoff structures 3 are typically formed by patterned deposition methods, such as the liftoff deposition method described in the Examples, below. Patterned deposition involves deposition of material after or concurrent with the imposition of a pattern, in contrast to application of a pattern after deposition. Suitable patterned deposition methods may include electron beam evaporation or thermal evaporation, and the like, and may be patterned by use of shadow-masks, by liftoff deposition, and the like. It will be understood that structures made according to patterned deposition methods will differ in structure from those made by other methods, including post-patterning methods which include etching of layers after deposition. The resulting structures may differ in the cant and curvature of surfaces and features, including wall, plateau and floor features, the texture or finish of surfaces and features, and the like.

Further with reference to FIGS. 1-3, the submount 1 according to the present invention may comprise solder layers 4, adjacent to and typically interposed between standoff structures 3. Any suitable solder may be used, including indium, silver, gold, tin, lead, bismuth, and alloys thereof. Solder layers 4 may be formed by any suitable method, including patterned deposition methods such as the liftoff deposition method described in the Examples, below.

Typically, solder layers 4 are patterned so as to partially fill the interstices between standoff structures 3. Typically, this pattern leaves a margin between solder layers 4 and standoff structures 3. This margin is typically between 5 and 100 microns, more typically between 10 and 75 microns. Typically, the height of the solder layers 4 is between 0.0 and 1.0 microns greater than the height of standoff structures 3, more typically between 0.1 and 0.8 microns greater. Where the height of the solder layer is greater than that of the standoff structures, a more reliable bond may be formed. With some solders, e.g. indium, the optical elements may be temporarily attached by pressure alone, prior to application of heat sufficient to cause solder reflow.

The laser diode chip 10 and second optical element 20 may be mounted on the submount 1 by any suitable method to form an optical assembly 40. Typically, the two optical elements are placed on the submount 1 and the submount is heated so as to cause reflow of the solder 4. The laser diode 10 is typically located so that the standoffs 3 are located away from the active stripe of the laser, allowing solder 4 to bond uniformly in that area, ensuring proper heat sinking during operation. The laser diode 10 is typically mounted with the epitaxial (heat-generating) surface against the submount 1, for use of the submount as a heat sink. Alignment along the Z axis, i.e., the axis normal to the submount, can be achieved by pressing the two optical elements into the melted solder until they rest on the standoffs. Alignment in the X and Y axes may be facilitated by using an infrared imaging system to see through the laser and waveguide substrates to alignment marks on the surfaces in contact with the submount, as described below in the Examples. The solder 4 is allowed to cool to form a complete optical assembly.

This invention is useful in the manufacture of communications devices employing laser diodes.

Objects and advantages of this invention are further illustrated by the following examples, but the particular materials and amounts thereof recited in these examples, as well as other conditions and details, should not be construed to unduly limit this invention.

### EXAMPLES

### Example 1

### Standoff Formation

A silicon substrate was subjected to a UV-ozone treatment. Silicon ribs approximately 1.0 μm high, 20 μm wide and 500 μm center-to-center were then deposited on the upper surface of the silicon substrate via the following liftoff procedure. A photoresist (type NR1-3000PY, manufactured by Futurrex, Franklin, N.J.) was spin coated on the entire upper surface of the silicon substrate. The photoresist was patterned by exposure to UV light through a mask bearing the desired ribbed pattern, followed by application of developer and removal of unexposed photoresist. A 50 Å titanium adhesion layer, followed by a 1.0 micron layer of silicon were deposited on the entire surface by electron beam evaporation. The photoresist was then removed by application of acetone and ultrasound to leave the desired pattern of silicon ribs.

A wetting layer of 1000 Å titanium and 500 Å platinum was subsequently deposited by electron beam evaporation on the upper surface. On the lower surface of the silicon substrate, a bonding layer of 1000 Å titanium was deposited by electron beam evaporation followed by a 2000 Å gold layer deposited by thermal evaporation, to facilitate the final bonding of the submount assembly to a heat sink or thermoelectric cooler.

### Example 2

### Standoff Formation

A silicon substrate was subjected to a UV-ozone treatment. Germanium posts having a square profile, 40 μm on a side, and a height of approximately 2.0 μm, were then deposited on the upper surface of the silicon substrate using the liftoff procedure described above.

A wetting layer of 1000 Å titanium and 500 Å platinum was subsequently deposited by electron beam evaporation on the upper surface. On the lower surface of the silicon substrate, a bonding layer of 1000 Å titanium was deposited by electron beam evaporation followed by a 2000 Å gold layer deposited by thermal evaporation, to facilitate the final bonding of the submount assembly to a heat sink or thermoelectric cooler.

### Example 3

### Solder Patterning

Indium solder was added to a substrate formed according to the procedure described in Example 1 by a liftoff procedure similar to that described in Example 1. The photoresist was patterned in ribs overlapping the existing silicon ribs already patterned on the upper surface of the substrate. The photoresist ribs were 50 μm wide, wider than the 20-μm wide silicon ribs, and were centered over the silicon ribs. A layer of indium 1.5 μm thick was deposited over the surface of the wetting layer and protected ribs. The photoresist and excess indium were removed by a liftoff procedure of acetone and ultrasound, revealing a pattern of 1.0 μm tall silicon ribs separated by 1.5 μm tall indium deposits.

### Example 4

### Solder Patterning

The procedure of Example 3 was followed using a substrate formed according to the procedure described in Example 2, except that indium was deposited in a thickness of 2.5 μm. The mask pattern used to prevent indium deposition on the posts left a margin of 60 μm around each post.

### Example 5

### Solder Patterning

In another embodiment, an etching procedure was used in applying indium solder to a substrate prepared according to the procedure of Example 1. A layer of indium 1.5 μm thick was deposited over the entire upper surface of the substrate, including the silicon ribs. A photoresist mask was applied and patterned so as to protect the entire upper surface except stripes 50 μm wide, centered on the 20-μm wide silicon ribs. The exposed indium was removed in an aqueous solution of 10% HCl. The etch terminated at the wetting layer, leaving the ribs unharmed. The photoresist was then removed to reveal the underlying indium layer.

### Example 6

### Assembly

A laser diode chip and a passive waveguide chip were mounted on a submount with standoffs made according to Examples 1 and 3 above. The two optical elements were mounted in optical alignment. Lateral alignment of the two chips was achieved with a micropositioner system. This alignment was facilitated by using an infrared imaging system to see through the laser and waveguide substrates to alignment marks on the surfaces in contact with the submount. Vertical alignment was controlled by the standoffs. Prior to solder reflow, the two chips rest on the solder. During solder reflow, the two chips were pressed into the solder and down onto the standoffs with tungsten point probes. The point probes allow the chips to settle freely onto the standoffs and be positioned by the standoffs without interference from the chip positioning apparatus. In addition, the point probes enabled the chips to be impelled into place without significant cooling of the chips, which might interfere with the formation of a good solder bond.

Various modifications and alterations of this invention will become apparent to those skilled in the art without departing from the scope and principles of this invention, and it should be understood that this invention is not to be unduly limited to the illustrative embodiments set forth hereinabove.

1. An optical assembly comprising:
a) at least one laser diode,
b) at least one second optical element, and
c) a submount comprising a substrate and a plurality of standoff structures
formed by patterned deposition onto said substrate,
wherein said at least one laser diode and said at least one second optical element contact said standoff structures.

2. The optical assembly according to claim 1 wherein said substrate comprises a material selected from the group consisting of: diamond, diamond-like materials, boron nitride and aluminum nitride.

3. The optical assembly according to claim 1 wherein said second optical element is a planar optical waveguide.

4. The optical assembly according to claim 1 wherein said substrate and said standoff structures are composed of different materials.

5. An optical assembly comprising:
a) at least one laser diode,
b) at least one second optical element, and
c) a submount comprising a substrate and a plurality of standoff structures,
wherein said substrate and said standoff structures are composed of different materials,
wherein said at least one laser diode and said at least one second optical element contact said standoff structures.

6. The optical assembly according to claim 5 wherein said substrate comprises a material selected from the group consisting of: diamond, diamond-like materials, boron nitride and aluminum nitride.

7. The optical assembly according to claim 5 wherein said second optical element is a planar optical waveguide.

8. A submount for use in an optical assembly comprising at least one laser diode and at least one second optical element, said submount comprising a substrate, a plurality of standoff structures, and solder layers adjacent to said standoff structures, wherein said standoff structures are formed by patterned deposition onto said substrate.

9. The submount according to claim 8 wherein said substrate comprises a material selected from the group consisting of: diamond, diamond-like materials, boron nitride and aluminum nitride.

10. The submount according to claim 8 wherein said substrate and said standoff structures are composed of different materials.

11. A submount for use in an optical assembly comprising at least one laser diode and at least one second optical element, said submount comprising a substrate, a plurality of standoff structures, and solder layers adjacent to said standoff structures, wherein said substrate and said standoff structures are composed of different materials.

12. The submount according to claim 11 wherein said substrate comprises a material selected from the group consisting of: diamond, diamond-like materials, boron nitride and aluminum nitride.

13. A submount for use in an optical assembly comprising at least one laser diode and at least one second optical element, said submount comprising a substrate, a plurality of standoff structures, and solder layers adjacent to said standoff structures, wherein said solder layers are greater in height from said substrate than said standoff structures.

14. The submount according to claim 13 wherein said substrate comprises a material selected from the group consisting of: diamond, diamond-like materials, boron nitride and aluminum nitride.

15. The submount according to claim 13 wherein said substrate and said standoff structures are composed of different materials.

16. The submount according to claim 13 wherein said standoff structures are formed by patterned deposition onto said substrate.

17. A method of making a submount for use in an optical assembly comprising at least one laser diode and at least one second optical element, said submount comprising a substrate, a plurality of standoff structures, and solder layers adjacent to said standoff structures, wherein said standoff structures are formed by patterned deposition onto said substrate.

18. The method according to claim 17 wherein said substrate comprises a material selected from the group consisting of: diamond, diamond-like materials, boron nitride and aluminum nitride.

19. The method according to claim 17 wherein said substrate and said standoff structures are composed of different materials.

20. The method according to claim 17 wherein said solder layers are greater in height from said substrate than said standoff structures.
